(19) United States
(12) Patent Application Publication
(10) Pub. No.: US 2007/0115889 A1
(43) Pub. Date: May 24, 2007

(54) Method and apparatus for providing trust guarantee transmission service in digital broadcasting system

(75) Inventors: Young-Joo Song, Suwon-si (KR); Jae-Yeon Song, Seoul (KR); Kook-Heul Lee, Yongin-si (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/546,080

(22) Filed: Oct. 11, 2006

(30) Foreign Application Priority Data
Oct. 11, 2005 (KR) 2005-95772

(51) Int. Cl. H04Q 7/00; H04L 12/28

(52) U.S. Cl. 370/331; 370/431

(57) ABSTRACT

Provided is a method and apparatus for providing a trust guarantee service in a digital broadcasting system, in which trust is guaranteed to a user in providing broadcasting streaming and file download services in a Digital Video Broadcasting (DVB) system. The method for providing a trust guarantee service through a terminal connected to a communication network in a portable broadcasting system includes the steps of determining an associated message generation request is received from the terminal, generating an associated message if the associated message generation request is received, and transmitting the generated associated message to a service provider.

### PRIORITY

This application claims priority under 35 U.S.C. § 119 to an application entitled “Method and Apparatus for Providing Trust Guarantee Transmission Service in Digital Broadcasting System” filed in the Korean Intellectual Property Office on Oct. 11, 2005 and assigned Serial No. 2005-95772, the contents of which are incorporated herein by reference.

### BACKGROUND OF THE INVENTION

1. Field of the Invention

The present invention generally relates to a method and apparatus for providing a trust guarantee service in a digital broadcasting system, and in particular, to a method and apparatus for providing a trusted transmission service in a Digital Video Broadcasting (DVB) system.

2. Description of the Related Art

With the recent development of data (audio/video) compression technology and communication technology, digital broadcasting capable of providing users with high quality audio and video services anywhere through fixed or mobile terminals has been implemented. Generally, digital broadcasting refers to a broadcasting service for providing high picture quality and Compact Disc (CD)-level sound quality to users in place of conventional analog broadcasting. Such digital broadcasting has evolved into two types, terrestrial-wave broadcasting and satellite broadcasting. The terrestrial-wave broadcasting refers to a digital broadcasting service enabling users to receive broadcasting through a terrestrial repeater. In contrast, satellite broadcasting refers to a digital broadcasting service in which digital broadcasting is received using a satellite as a repeater.

Examples of a digital broadcasting system include Digital Audio Broadcasting (DAB), Digital Radio Broadcasting (DRS), Digital Audio Radio System, and a Digital Multimedia Broadcasting (DMB) incorporating audio, video and data services. Recently, the European DAB system, i.e., the European Research Coordination Agency project-147 (Eureka 147) system and the Digital Video Broadcasting-Handheld (DVB-H) system that reinforce mobility and portability of one of the digital broadcasting standards, i.e., the Digital Video Broadcasting-Terrestrial (DVB-T) system have attracted attention.

In the DVB system, Moving Picture Experts Group (MPEG)-2 Transport Stream (TS) based broadcasting data can be multiplexed and IP based data streams can be simultaneously transmitted. In the DVB system, various services can be multiplexed and transmitted through a single IP stream. A terminal having received data of the transmitted IP stream demultiplexes the data, demodulates separate services, and outputs the demodulated services to a user through a screen.

FIG. 1 shows a structure of a protocol for transmitting related contents for a broadcasting stream and file download service in a DVB system.

The protocol structure for the DVB service uses a Realtime Transport Protocol (RTP) 120 based on a User Datagram Protocol (UDP) 110 for a dynamic streaming service such as transmission of audio, video, and speech signals and uses a File delivery over Unidirectional Transport (FLUTE) protocol 130 based on the UDP 110 for static files such as a 3GPP file format, binary data, still images, and texts and Service Announcement and Metadata.

The protocol structure for the DVB service increases the speed of service transmission based on the UDP both for the broadcasting streaming service and the file download, but it cannot guarantee trust in transmission. Therefore, the DVB system requires a method by which an individual user can request file retransmission and file error correction for a trusted service from a service transmitter.

### SUMMARY OF THE INVENTION

It is, therefore, an object of the present invention to provide a method and apparatus for providing a trust guarantee service in a digital broadcasting system, in which trust is guaranteed to a user in providing broadcasting streaming and file download services in a Digital Video Broadcasting (DVB) system.

It is another object of the present invention to provide a method and apparatus for providing a trust guarantee service in a digital broadcasting system, in which a message required for guaranteeing trust in providing broadcasting streaming and file download services in the DVB system is generated.

According to one aspect of the present invention, there is provided a method for providing a trust guarantee service through a terminal connected to a communication network in a portable broadcasting system. The method includes determining if an associated message generation request is received from the terminal, generating an associated message if the associated message generation request is received, and transmitting the generated associated message to a service provider.

According to another aspect of the present invention, there is provided a method for receiving a trust guarantee service in a portable broadcasting system. The method includes receiving an associated message from a service provider through a network and checking the received associated message and transmitting a file correction request or a reception report to the service provider according to a request included in the associated message.

According to another aspect of the present invention, there is provided a transmitter for transmitting a trust guarantee service through a terminal connected to a communication network in a portable broadcasting system. The transmitter includes a message generator for determining if an associated message generation request is received from the terminal and generating a associated message if the associated message generation request is received, an encapsulator for encapsulating the generated associated message to a transmission side, a multiplexer for multiplexing the encapsulated associated message, and a modulator for modulating the multiplexed associated message and transmitting the modulated associated message to the terminal through an antenna.

According to another aspect of the present invention, there is provided a receiver for receiving a trust guarantee service in a portable broadcasting service. The receiver includes a demodulator for receiving a signal from a service provider through a network and demodulating the received signal, a demultiplexer for demultiplexing the demodulated signal, a decapsulator for decapsulating an IP encapsulated packet of the demultiplexed signal for demodulation into an IP stream, and a message processor for transmitting a file correction request or a reception report to the service provider according to a request included in an associated message of the IP stream.

### BRIEF DESCRIPTION OF THE DRAWINGS

The above and other objects, features and advantages of the present invention will become more apparent from the following detailed description when taken in conjunction with the accompanying drawings in which:

FIG. 1 shows the structure of a protocol for a conventional digital video service;

FIG. 2 is a block diagram of a transmitter according to the present invention;

FIG. 3 is a block diagram of a receiver according to the present invention;

FIG. 4 shows the structure of an associated message including file retransmission request information and a reception report request;

FIG. 5 shows the structure of a message for file retransmission request information for each user according to the present invention;

FIG. 6 shows the structure of a message for broadcast/multicast file retransmission request information according to the present invention;

FIG. 7 shows the structure of a message for a reception report request according to the present invention;

FIG. 8 shows the structure of an associated message for a reception report according to the present invention;

FIG. 9 shows the structure of a message for a reception success report according to the present invention;

FIG. 10 shows the structure of a message for a statistical information report after a reception success according to the present invention;

FIG. 11 shows the structure of a message for a statistical information report after all receptions according to the present invention;

FIG. 12 is a control flowchart for generating a associated message at a transmitter according to the present invention; and

FIGS. 13A and 13B are control flowcharts for receiving a reception report at a receiver according to the present invention.

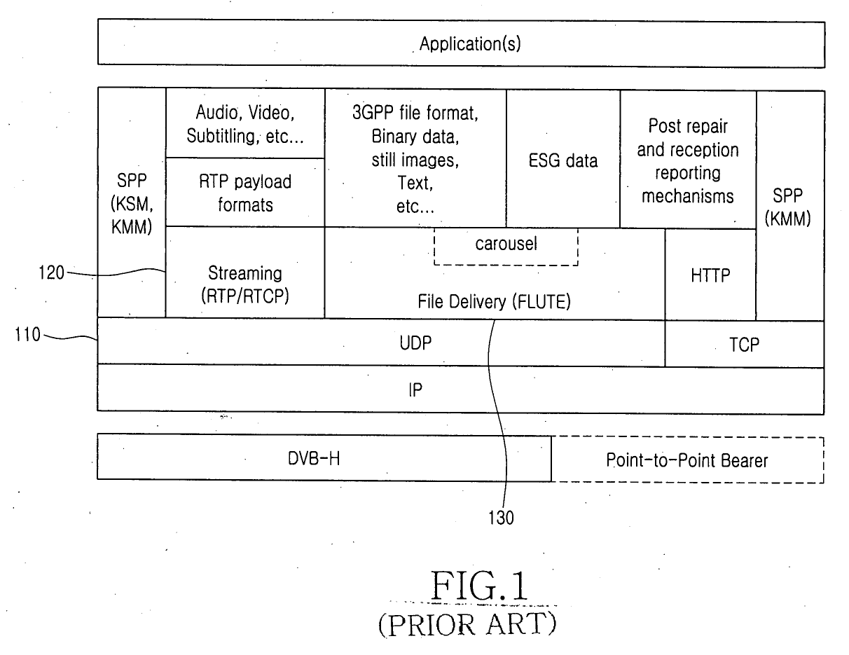

### DETAILED DESCRIPTION OF THE PREFERRED EMBODIMENT

Detailed description of known functions and configurations herein incorporated is omitted for conciseness. Terms used herein are defined based on functions in the present invention and may vary according to users, operators' intent or usual practices. Therefore, the terms should be understood based on the contents of the specification.

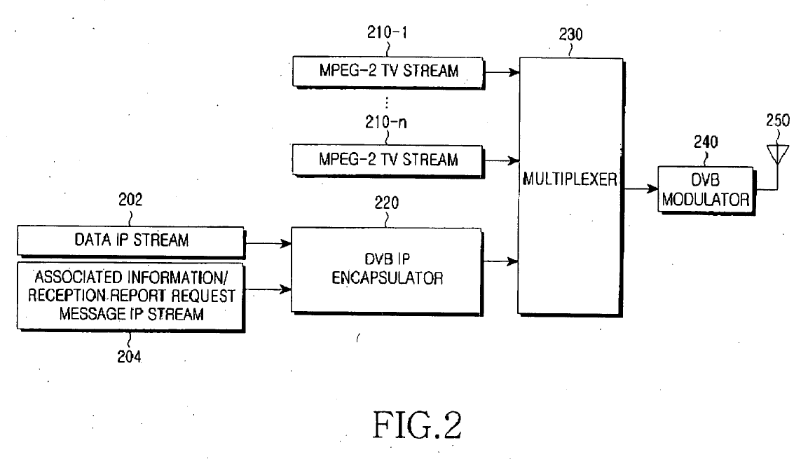

FIG. 2 is a block diagram of a transmitter in a Digital Video Broadcasting (DVB) system according to the present invention.

Referring to FIG. 2, a plurality of MPEG-2 TV streams 210-1-210-n are input to a multiplexer 230. An IP stream is also input to the multiplexer 230.

IP based service data (a data IP stream) 202 is input as the IP stream. Associated message information generated to transmit information for generation of a file retransmission request and a reception report for trust guarantee with respect to the MPEG-2 TV stream data and IP stream data is also included in an IP stream (unified information/reception report request message IP stream) 204. Unified information/reception report request message IP stream 204 is an IP stream generated by the transmitter to provide a transmission service. It includes a reception report and a retransmission request for each user. It also provides a trusty transmission service to a user in providing broadcasting streaming and file download services in a digital broadcasting system according to the present invention.

Input IP streams 202 and 204 are input to a DVB IP encapsulator 220. Upon reception of the data IP stream 202 and the unified information/reception report request message 204, DVB IP encapsulator 220 encapsulates the received IP streams 202 and 204 into an MPEG-2 TS and outputs the MPEG-2 TS, together with the MPEG-2 TV streams 210-1-210-n, to multiplexer 230.

Multiplexer 230 multiplexes the MPEG-2 TSs. The multiplexed MPEG-2 TSs are input to a DVB modulator 240. DVB modulator 240 modulates the multiplexed MPEG-2 TSs into an Orthogonal Frequency Divisional Multiplexing (OFDM) symbol and then transmits the OFDM symbol to the receiver through an antenna 250.

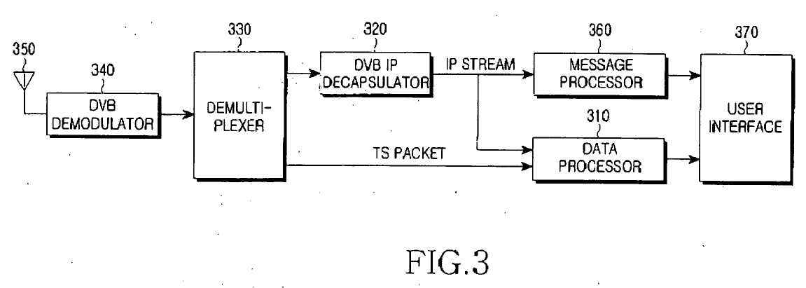

FIG. 3 is a block diagram of a receiver in the DVB system according to the present invention.

A signal received through antenna 350 is input to a DVB demodulator 340. DVB demodulator 340 performs OFDM demodulation on the received signal. OFDM demodulated data is input to a demultiplexer 330. Demultiplexer 330 demultiplexes the OFDM demodulated data into an IP encapsulated packet and an MPEG-2 TS packet.

The MPEG-2 TS packet is input to a data processor 310. The data processor 310 performs a procedure for showing the corresponding service to a user through user interface 370.

The IP encapsulated packet is input to a DVB IP encapsulator 320. DVB IP encapsulator 320 demodulates the IP encapsulated packet into an IP stream. The IP stream is divided into an Electronic Service Guide (ESG) stream and a data stream. The data stream is input to data processor 310 like the TS packet. The ESG stream is input to a message processor 360. The ESG message includes the associated message transmitted by the transmitter. The associated message is input to a retransmission procedure processor (not shown) of the message processor 360. The retransmission procedure processor in message processor 360 analyzes the data of the received associated message, transmits a file retransmission request and a reception report based on information included in the associated message if retransmission of streaming and file download services should be requested.

It is obvious that the message processor 360 transmits a message for file retransmission and reception report to the receiver through an RF module (not shown) when transmitting the file retransmission request and the reception report based on the information included in the associated message.

In the present invention, two associated messages provide a trust guarantee service.

The first one is an associated message including file retransmission request information and a reception report request and is delivered from the transmitter to the user.

The second one is a reception report message for user's reception report and is delivered from the user to the transmitter.

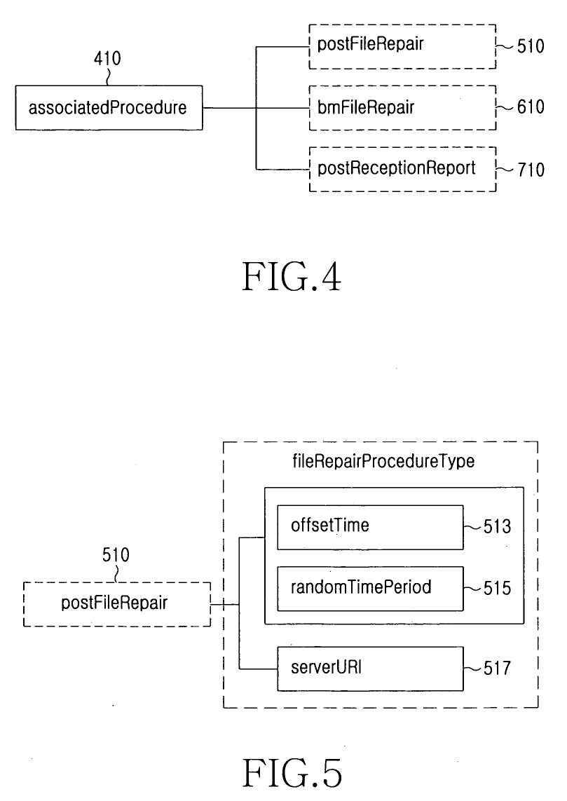

The associated message including the file retransmission request information and the reception report request will be described with reference to FIG. 4. FIG. 4 shows the structure of an associated message 410 including the file retransmission request information and the reception report request according to the present invention.

Referring to FIG. 4, associated message 410 includes file retransmission request information (postFileRepair) 510 for each user, broadcast/multicast file retransmission request information (bmFileRepair) 610, and a reception report request (postReceptionReport) 710. The associated message 410 may include all the three kinds of information or may not include any of them. An XML description associated message 410 follows:

```
  <xs:element name=“associatedProcedureDescription”>
    <xs:complexType>
      <xs:sequence>
      <xs:element name=“postFileRepair”
      type=“fileRepairProcedureType”
minOccurs=“0”/>
      <xs:element name=“bmFileRepair”
      type=“bmFileRepairProcedureType”
minOccurs=“0”/>
      <xs:element name=“postReceptionReport”
type=“receptionReportProcedureType” minOccurs=“0”/>
      </xs:sequence>
    </xs:complexType>
  </xs:element>
```

The structure of the file retransmission request information (postFileRepair) for each user included in the associated message having the file retransmission request information and the reception report request is shown in FIG. 5. FIG. 5 shows the structure of a message for file retransmission request information for each user according to the present invention. An XML description of the message follows:

```
  <xs:complexType name=“fileRepairProcedureType”>
      <xs:sequence>
          <xs:element name=“serverURI” type=“xs:anyURI”
maxOccurs=“unbounded”/>
        </xs:sequence>
        <xs:attributeGroup ref=“backoffTime”/>
    </xs:complexType>
```

File retransmission request information (postFileRepair) 510 for each user includes server information (ServerURI) 517 indicating information about a server to which a reception report is to be transmitted. If there is missing data, the user may select a server from a server list specified in the file retransmission request information 510 to transmit a file retransmission request. When transmitting the file retransmission request, the user may delay the file retransmission request using back-off time specified in file retransmission request information 510. Delaying a request by a predetermined period of time can dispel confusion and reduce the load of a server that may occur when a plurality of users simultaneously transmit retransmission requests to a specific server. The back-off time is equal to the sum of an offset time (offsetTime) 513 and a random time period (randomTimePeriod) 515. In other words, the user calculates random time period 515 within a random time interval starting from 0 using statistical uniform distribution sampling and adds the calculated random time period 515 to offset time 513, thereby determining the back-off time. An XML description of the back-off time follows:

```
  <xs:attributeGroup name=“backoffTime”>
    <xs:attribute name=“offsetTime” type=“xs:unsignedLong”
    use=“optional”/>
      <xs:attribute name=“randomTimePeriod”
      type=“xs:unsignedLong”
use=“required”/>
  </xs:attributeGroup>
```

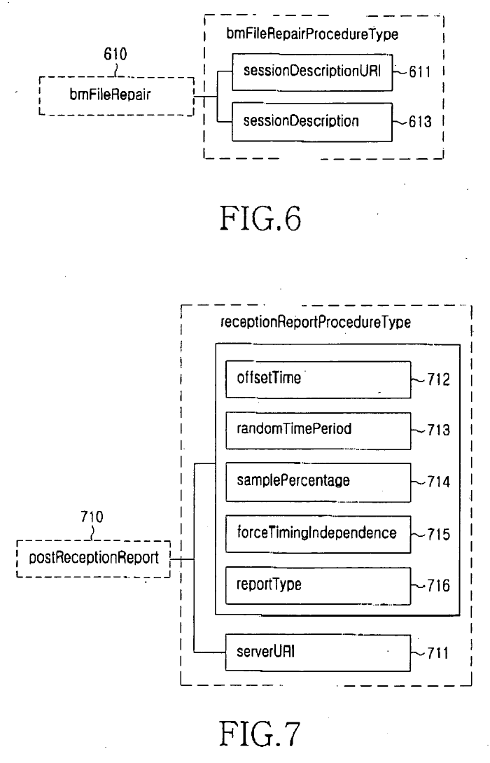

Broadcast/multicast file retransmission request information (bmFileRepair) 610 contained in the associated message includes the file retransmission request information and the reception report request as shown in FIG. 6. FIG. 6 shows the structure of a message for the broadcast/multicast file retransmission request information 610 according to the present invention.

Broadcast/multicast file retransmission request information 610 includes information about a session description (sessionDescription) 613 which is referred to when the user requests retransmission of a file that is transmitted in broadcast/multicast modes. The session information may be transmitted by being directly attached to the broadcast/multicast file retransmission request information 610 or only a position (sessionDescriptionURI) 611 in which the session information can be referred to may be transmitted through the broadcast/multicast file retransmission request information 610. An XML description of the message for broadcast/multicast file retransmission request information 610 follows:

```
  <xs:complexType name=“bmFileRepairProcedureType”>
      <xs:choice>
          <xs:element name=“sessionDescriptionURI”
          type=“xs:anyURI”/>
          <xs:element name=“sessionDescription”>
              <xs:simpleType name=“sessionDescriptionType”>
                <xs:restriction base=“xs:string”/>
                <!-- Note: InlinedSession Description below must
                be embedded
in CDATA -->
              </xs:simpleType>
            <xs:element>
        </xs:choice>
    </xs:complexType>
```

The structure of the reception report request information (postReceptionReport) contained in the associated message includes the file retransmission request information and the reception report request as shown in FIG. 7. FIG. 7 shows the structure of a message for the reception report request 710 according to the present invention.

Referring to FIG. 7, reception report request 710 includes a server to which a reception report is to be transmitted, a report point of time, information for selecting a destination to which the reception report is to be transmitted, information for reducing a load to the server, and a reception report type. An XML description of the message for reception report request 710 follows:

```
  <xs:complexType name=“receptionReportProcedureType”>
      <xs:sequence>
        <xs:element name=“serverURI” type=“xs:anyURI”
maxOccurs=“unbounded”/>
      </xs:sequence>
      <xs:attributeGroup ref=“backoffTime”/>
    <xs:attribute name=“samplePercentage” default=“100”
    use=“optional”>
      <xs:simpleType>
          <xs:restriction base=“xs:decimal”>
          <xs:fractionDigits value=“3”/>
          <xs:minInclusive value=“0”/>
          <xs:maxInclusive value=“100”/>
          </xs:restriction>
      </xs:simpleType>
    </xs:attribute>
    <xs:attribute name=“forceTimingIndependence” type=“xs:boolean”
    default=“0”
use=“optional”/>
    <xs:attribute name=“reportType” default=“rack” use=“optional”>
      <xs:simpleType>
        <xs:restriction base=“xs:string”>
              <xs:enumeration value=“rack”/>
              <xs:enumeration value=“star”/>
              <xs:enumeration value=“star-all”/>
        </xs:restriction>
      </xs:simpleType>
      </xs:attribute>
    </xs:complexType>
    <xs:attributeGroup name=“backoffTime”>
        <xs:attribute name=“offsetTime” type=“xs:unsignedLong”
        use=“optional”/>
        <xs:attribute name=“randomTimePeriod”
type=“xs:unsignedLong” use=“required”/>
    </xs:attributeGroup>
```

Referring to FIG. 7, server information (ServerURI) 711 indicates information about a server to which a reception report is to be transmitted, and the back-off time indicates a point in time at which the reception report is to be transmitted and is equal to the sum of offset time (offsetTime) 712 and random time period (randomTimePeriod) 713. The receiver delays the reception report by the calculated back-off time and then transmits the delayed reception report to the server.

Sample percentage (samplePercentage) 714 is a sample of information for determining whether the receiver transmits the reception report. A random decimal number having three decimal places selected from among decimals between 0 and 100 using statistical uniform distribution sampling and a sample percentage restriction base for preventing manipulation by a third party are transmitted to the receiver through sample percentage 714. The sample percentage restriction base includes a field indicating a type, a field indicating the number of decimal places, a field indicating a maximum value and a minimum value. The receiver having received the sample percentage 714 also selects a random decimal number from among decimals between 0 and 100, generates a reception report if the selected decimal is less than the selected random decimal of the sample percentage 714, and transmits the generated reception report to the server.

Time independent information (forceTimingIndependence) 715 is used to make the reception report using a connection for reception report message delivery after the back-off time without using a connection with the server for a file retransmission request, thereby reducing confusion and load of the server.

Report type (reportType) 716 is classified into three types: a simple reception success report (receptionAcknowledgement: RAck), a statistical information report (statisticalReporting: StaR) including session information of a successful reception, and a statistical information report (statisticalReporting for all reception: StaR-all) associated with all receptions.

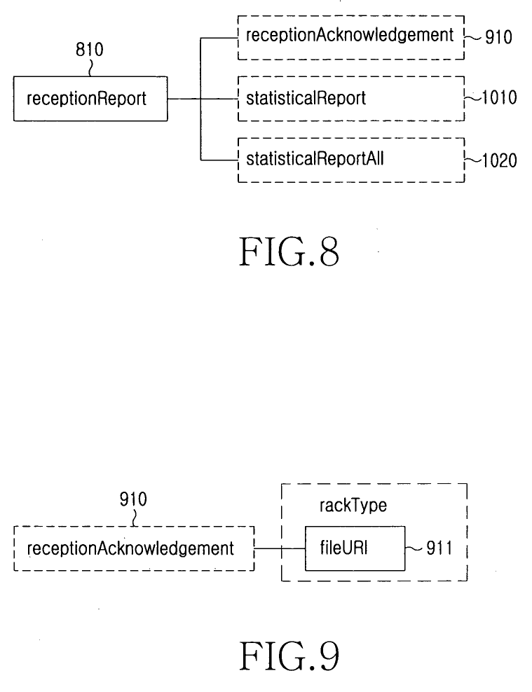

The second associated message as a call message for a user's reception report that is transmitted from the user to the transmitter will be described with reference to FIG. 8. FIG. 8 shows the structure of an associated message for a reception report according to the present invention.

FIG. 8 shows the structure of an associated message for a reception report 810. Reception report 810 is classified into three types: a simple reception success report (receptionAcknowledgement: RAck) 910, a statistical information report (statisticalReport: StaR) 1010 including session information of a successful reception, and a statistical information report for all reception (statisticalReportAll: StaR-all) 1020 associated with all receptions. Information to be included in the reception report 810 varies according to types. An XML description for describing the message for reception report 810 follows:

```
  <xs:element name=“receptionReport”>
      <xs:complexType>
          <xs:choice>
            <xs:element name=“receptionAcknowledgement”
type=“rackType”/>
            <xs:element name=“statisticalReport” type=“starType”/>
            <xs:element name=“statisticalReportAll”
type=“starAllType”/>
        </xs:choice>
    </xs:complexType>
  </xs:element>
```

FIG. 9 shows the structure of a message for the simple reception success report (receptionAcknowledgement: RAck) 910.

Simple reception success report 910 includes a field specifying an ID (URI) 911 of a successfully received file. An XML description of the message for the reception success report (receptionAcknowledgement: RAck) 910 follows:

```
<xs:complexType name=“rackType”>
  <xs:sequence>
    <xs:element name=“fileURI” type=“xs:anyURI”
minOccurs=“0” maxOccurs=“unbounded”/>
    </xs:sequence>
  </xs:complexType>
```

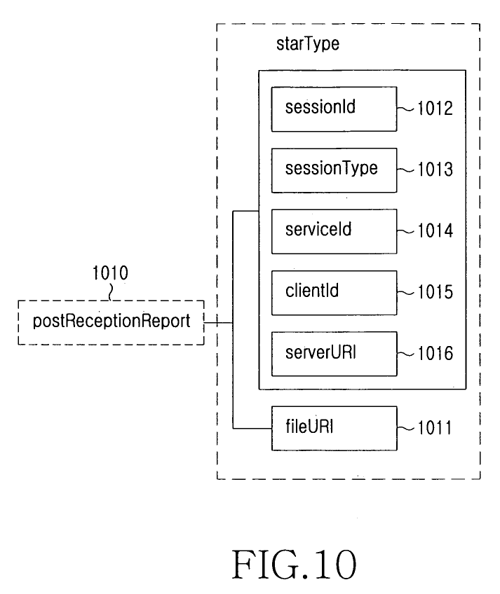

FIG. 10 shows the structure of a message for the statistical information report (postReceptionReport: StaR) 1010 including session information of the reception success.

Statistical information report 1010 includes an ID (fileURI) 1011 of a successfully received file, a session ID (sessionid) 1012 of the successfully received file, a session type (sessiontype) 1013, a service ID (serviceid) 1014, a receiver ID (clientid) 1015, and a server ID (serverURI) 1016. An XML description of a message for the statistical information report 1010 after the reception success follows:

```
  <xs:complexType name=“starType”>
    <xs:sequence>
      <xs:element name=“fileURI” type=“xs:anyURI”
minOccurs=“0” maxOccurs=“unbounded”/>
    </xs:sequence>
    <xs:attribute name=“sessionId” type=“xs:string” use=“optional”/>
    <xs:attribute name=“sessionType” use=“optional”>
      <xs:simpleType>
        <xs:restriction base=“xs:string”>
          <xs:enumeration value=“download”/>
          <xs:enumeration value=“streaming”/>
          <xs:enumeration value=“mixed”/>
      </xs:restriction>
    </xs:simpleType>
  </xs:attribute>
  <xs:attribute name=“serviceId” type=“xs:string” use=“optional”/>
  <xs:attribute name=“clientId” type=“xs:anyURI” use=“optional”/>
  <xs:attribute name=“serverURI” type=“xs:anyURI” use=“optional”/>
</xs:complexType>
```

The file ID 1011 indicates ID information of a successfully received file, the session ID 1012 indicates the session ID of the successfully received file, and the session type 1013 indicates whether a session is intended for streaming or download. Service ID 1014 indicates the ID of a service including the successfully received file, receiver ID 1015 indicates the ID of the receiver of the successfully received file, and server ID 1016 indicates the ID of the server of the successfully received file.

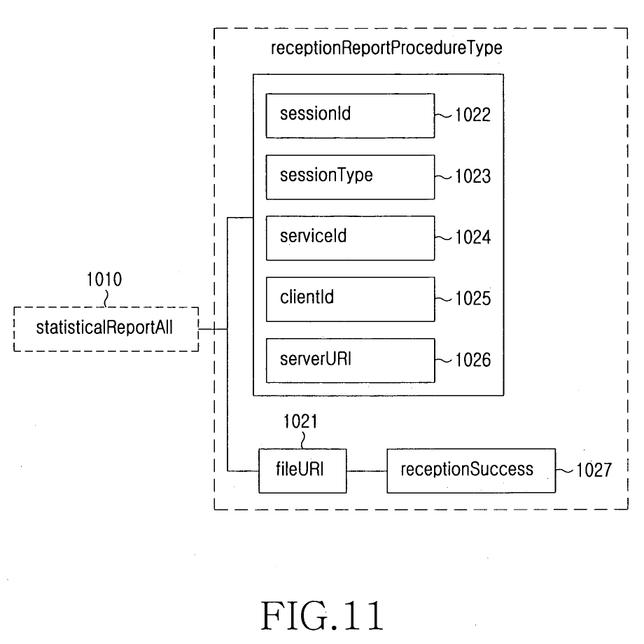

FIG. 11 shows the structure of a message for the statistical information report (statisticalReportAll: StaR-all) 1020 associated with all receptions according to the present invention.

Statistical information report 1020 includes the same information as the statistical information report 1010, i.e., an ID (URI) 1021 of a successfully received file, a session ID 1022 of the successfully received file, a session type 1023, a service ID 1024, a receiver ID 1025, and a server ID 1026, and further includes information (receptionSuccess) 1027 indicating a success or failure in the reception of a file. An XML description of a message for the statistical information report 1020 is as follows:

```
<xs:complexType name=“starAllType”>
      <xs:sequence>
          <xs:element name=“fileURI” minOccurs=“0”
          maxOccurs=“unbounded”>
                <xs:complexType>
                  <xs:simpleContent>
                    <xs:extension base=“xs:anyURI”>
                      <xs:attribute name=“receptionSuccess”
                      type=“xs:boolean”/>
                    </xs:extension>
                  </xs:simpleContent>
            </xs:complexType>
        </xs:element>
      </xs:sequence>
      <xs:attributeGroup ref=“relatedInfo”/>
  </xs:complexType>
  <xs:attributeGroup name=“relatedInfo”>
    <xs:attribute name=“sessionId” type=“xs:string” use=“optional”/>
    <xs:attribute name=“sessionType” use=“optional”>
        <xs:simpleType>
          <xs:restriction base=“xs:string”>
              <xs:enumeration value=“download”/>
              <xs:enumeration value=“streaming”/>
              <xs:enumeration value=“mixed”/>
        </xs:restriction>
      </xs:simpleType>
    </xs:attribute>
    <xs:attribute name=“serviceId” type=“xs:anyURI” use=“optional”/>
    <xs:attribute name=“clientId” type=“xs:anyURI” use=“optional”/>
    <xs:attribute name=“serverURI” type=“xs:anyURI” use=“optional”/>
  </xs:attributeGroup>
</xs:schema>
```

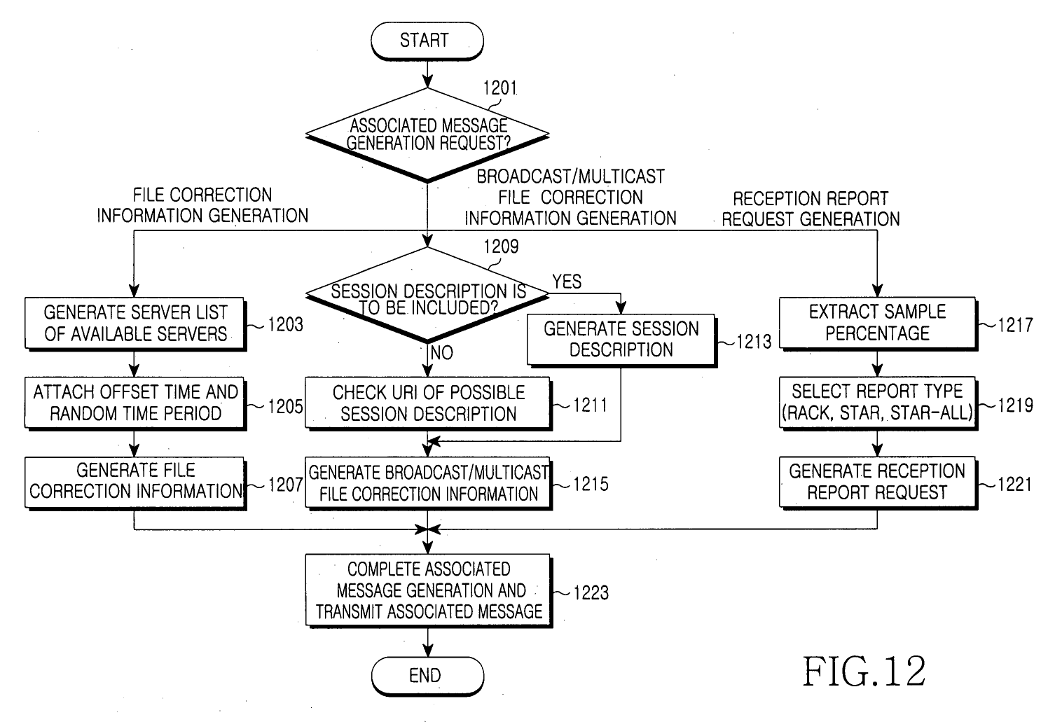

FIG. 12 is a control flowchart for generating an associated message at a transmitter according to the present invention.

Referring to FIG. 12, the transmitter determines whether an associated message generation request is received from the receiver in step 1201. If the transmitter receives an associated message generation request for file correction request information generation, it generates a server list of available servers capable of processing a file retransmission request in step 1203 and sets user's offset time and random time period and attaches them to the associated message in step 1205. The transmitter generates the file retransmission request information (postFileRepair) including server information, offset time, and a random time in step 1207.

If the transmitter receives an associated message generation request for broadcast/multicast file correction request information generation in step 1201, the transmitter determines whether to include a session description in the associated message in step 1209. If the session description is not to be included in the associated message, the transmitter checks a position (sessionDescriptionURI) in which a possible session description can be referred to. If the session description is to be included in the associated message in step 1209, the transmitter generates a session description (sessionDescription) in step 1213.

The transmitter generates broadcast/multicast file correction request information (bmFileRepair) including the URI checked in step 1211 and the session description generated in step 1213.

If the transmitter receives an associated message generation request for reception report request generation in step 1201, the transmitter extracts sample percentage (samplePercentage) that is a sample of information for determining whether the user has to transmit a reception report in step 1217. At this time, a random decimal number having three decimal places (between 0 and 100) using statistical uniform distribution sampling is transmitted.

The transmitter selects a report type in step 1219. The report type is classified into three types: a simple reception success report (receptionAcknowledgement: RAck), a statistical information report (statisticalReporting: StaR) including session information of a successful reception, and a statistical information report (statisticalReporting for all reception: StaR-all) associated with all receptions.

In step 1221, the transmitter generates a reception report request (postReceptionREport) including a sample percentage having a decimal number selected from among decimals between 0 and 100, a desired report type, and a server list of servers to which reception reports are to be transmitted.

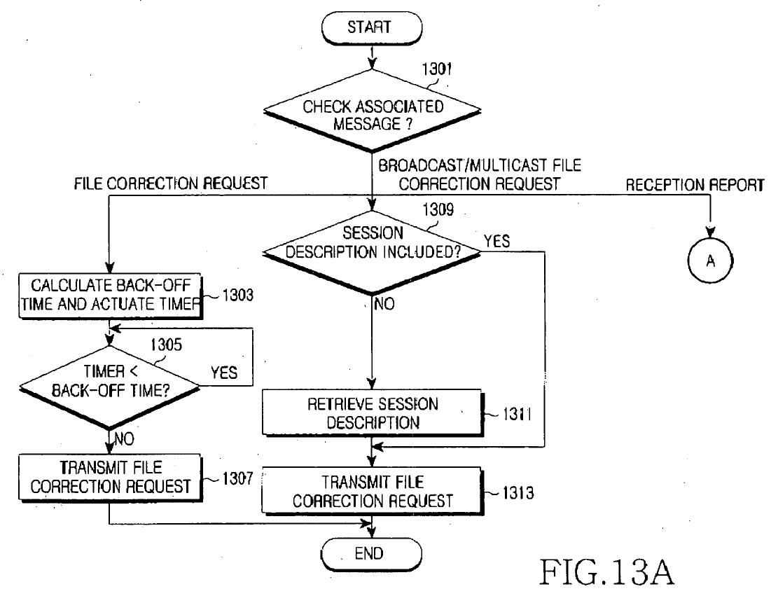

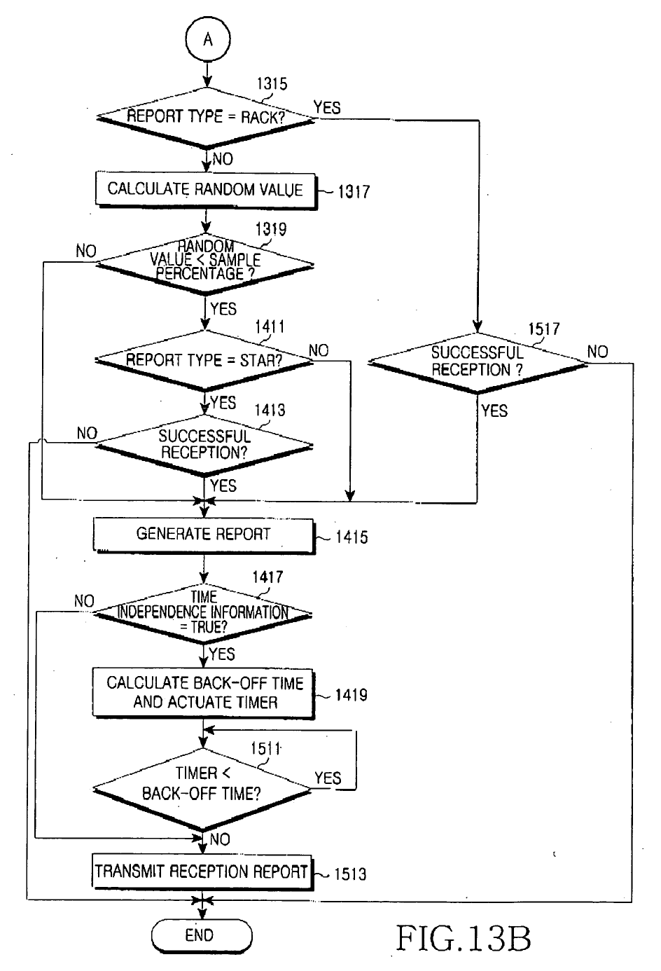

FIGS. 13A and 13B are control flowcharts for receiving a reception report at the receiver according to the present invention.

Referring to FIG. 13A, the receiver checks an associated message received from transmitter 1301. In other words, the receiver checks if the associated message includes the file retransmission request information (postFileRepair) for each user as shown in FIG. 5, the broadcast/multicast file retransmission request information (bmFileRepair) as shown in FIG. 6, and all information about the reception report request (postReceptionReport) as shown in FIG. 7, and performs a procedure defined for each information as follows.

If the checked associated message requires a procedure for a file correction request, the receiver calculates a random delay time using the back-off time and actuates a timer in step 1303. If the random delay time is less than a time set in the timer in step 1305, the receiver repeats step 1305. However, if the random delay time is greater than or equal to the time set in the timer, the receiver goes to step 1307 to transmit the file correction request to the transmitter.

If the checked associated message requires execution of a procedure for a broadcast/multicast file correction request, the receiver goes to step 1309 to determine whether a session description is included in the associated message. If there is a session description in the associated message, the receiver goes to step 1313 to connect to a session for a retransmission request according to the session description. In other words, the receiver transmits a file correction request for the retransmission request. Otherwise, the receiver retrieves a session description from a position (URI) in which session information can be referred to and makes a connection to a new session for retransmission in step 1311.

If the checked associated message requires execution of a procedure for a reception report request, the receiver determines whether the report type is RAck in step 1315 as shown in FIG. 13B. If the report type is RAck, the receiver determines whether a reception is successful in step 1517. If the reception is not successful, the receiver terminates the procedure. If the reception is successful, the receiver goes to step 1415 to initiate the procedure for reception report generation.

If the report type is not RAck, the receiver calculates a random number (decimal) having three decimal places (between 0 and 100) using statistical uniform distribution sampling in step 1317. The receiver determines whether the calculated random value is less than the random value of the sample percentage in step 1319. If the calculated random value is equal to or greater than the random value of the sample percentage, the receiver goes to step 1415 to initiate the procedure for reception report generation.

If the calculated random number is less than the sample percentage, the receiver determines whether the type of the reception report to be generated is a statistical information report (statisticalReporting: StaR) about a successful reception. If the report type is not the statistical information report, i.e., the report type is a statistical information report (statisticalReporting for all reception: StaR-all) associated with all receptions, the receiver goes to step 1415 to initiate the procedure for reception report generation. However, if the report type is StaR, the receiver determines whether a reception is successful in step 1413. If the reception is not successful, the receiver terminates the procedure. If the reception is successful, the receiver goes to step 1415 to initiate the procedure for reception report generation.

If the report type is RAck or StaR and StaR-all and the selected random number is less than that of the sample percentage, the receiver generates a reception report for each report type in step 1415 and then checks setting of time independence information in step 1417. If the time independence information is not set, the receiver goes to step 1513 to generate a reception report and transmits the reception report to the server using a current connection. However, if the time independence information is set, the receiver calculates the back-off time and actuates the timer in step 1419. At this time, the receiver determines whether a time set in the timer is less than the back-off time, i.e., a random delay time in step 1511. Step 1511 is repeated until the set time is equal to the back-off time. However, if the set time is greater than or equal to the back-off time, the receiver establishes a new connection and transmits the reception report to the server in step 1513.

As described above, according to the present invention, each user can request file retransmission and file error correction from a service transmitter in a digital broadcasting system, thereby providing trust guarantee.

Moreover, high-level trust can be guaranteed to the user in providing broadcasting streaming and file download services in a DVB system.

Furthermore, trust can be guaranteed to the user by generating an associated message in providing broadcasting streaming and file download services in a DVB system.

While the present invention has been shown and described with reference to preferred embodiments thereof, it will be understood by those skilled in the art that various changes in form and details may be made therein without departing from the spirit and scope of the invention.

What is claimed is:

1. A method for providing a trust guarantee service through a terminal connected to a communication network in a portable broadcasting system, the method comprising the steps of:
determining if an associated message generation request is received from the terminal;
generating an associated message if the associated message generation request is received; and
transmitting the generated associated message to a service provider.

2. The method of claim 1, wherein if the associated message is an associated message for file correction information generation, further comprising:
generating a server list of available servers;
setting a offset time and a random time period and attaching them to the associated message; and
generating file correction information including the server list, the offset time, and the random time period.

3. The method of claim 1, wherein if the associated message is an associated message for broadcast/multicast file correction information generation, further comprising generating broadcast/multicast file correction information by including a session description (sessionDescription) and a position (sessionDescriptionURI) in which the session description can be referred to in the associated message.

4. The method of claim 3, further comprising:
determining whether to include the session description in the associated message;
generating the session description if the session description is to be included in the associated message; and
generating the broadcast/multicast file correction information by including the generated session description.

5. The method of claim 4, further comprising:
determining a position (sessionDescriptionURI) in which the session description can be referred to if the session description is not to be included in the associated message; and
generating the broadcast/multicast file correction information by including the determined position.

6. The method of claim 1, wherein if the associated message is a associated message for reception report request generation, further comprising:
extracting a sample percentage (samplePercentage) that is sample information for determining whether to transmit a reception report;
selecting a reception report type; and
generating a reception report request including the sample percentage, the reception report type, and a server list of servers to which a reception report is to be transmitted.

7. The method of claim 6, wherein the step of selecting the reception report type comprises selecting one of a reception success report (receptionAcknowledgement: RAck), a statistical information report (statisticalReporting: StaR) including session information associated with a successful reception, and a statistical information report (statisticalReporting for all reception: StaR-all) associated with all receptions.

8. The method of claim 6, wherein the step of extracting the sample percentage comprises extracting a random decimal having three decimal places selected from among decimals between 0 and 100 using statistical uniform distribution sampling.

9. A method for receiving a trust guarantee service in a portable broadcasting system, the method comprising the steps of:
receiving an associated message from a service provider through a network and checking the received associated message; and
transmitting a file correction request or a reception report to the service provider according to a request included in the associated message.

10. The method of claim 9, wherein if the associated message includes a file correction request, further comprising:
calculating a random delay time using a back-off time and actuating a timer; and
transmitting the file correction request to the service provider if the random delay time is equal to or greater than a time set in the timer.

11. The method of claim 9, wherein if the associated message includes a broadcast/multicast file correction request, further comprising making a connection to a session for a retransmission request according to a session description.

12. The method of claim 11, further comprising:
determining if the session description is included in the associated message; and
making a connection to a session for a retransmission request according to the session description if the session description is included in the associated message.

13. The method of claim 12, if the session description is not included in the associated message, further comprising retrieving a session description from a position in which session information can be referred to and making a connection to a session for a retransmission request.

14. The method of claim 9, wherein if the associated message includes a reception report request, further comprising:
determining a reception report type;
calculating a random number having three decimal places between 0 and 100 using statistical uniform distribution sampling if the reception report type is a statistical information report (statisticalReporting: StaR) including session information associated with a successful reception or a statistical information report (statisticalReporting for all reception: StaR-all) associated with all receptions;
determining if the calculated random number is less than a sample percentage; and
generating the reception report if the calculated random number is less than the sample percentage.

15. The method of claim 14, wherein if the reception report type is a reception success report (receptionAcknowledgement: RAck), further comprising generating the reception report.

16. The method of claim 14, further comprising:
generating a reception report for each reception report type;
calculating a back-off time, making a delay by the calculated time, establishing a new connection, and transmitting the reception report to the service provider if time independence information is set.

17. The method of claim 16, wherein if the time independence information is not set, further comprising generating the reception report and transmitting the reception report to the service provider using a current connection.

18. A transmitter for transmitting a trust guarantee service through a terminal connected to a communication network in a portable broadcasting system, the transmitter comprising:
a message generator for determining if an associated message generation request is received from the terminal and generating a associated message if the associated message generation request is received;
an encapsulator for encapsulating the generated associated message to a transmission side;
a multiplexer for multiplexing the encapsulated associated message;
a modulator for modulating the multiplexed associated message and transmitting the modulated associated message to the terminal through an antenna.

19. The transmitter of claim 18, wherein if the associated message is an associated message for file correction information generation, the message generator generates a server list of available servers, sets an offset time and a random time period and attaches them to the associated message, and generates file correction information including the server list, the offset time, and the random time period.

20. The transmitter of claim 19, wherein if the associated message is for broadcast/multicast file correction information generation, the message generator generates broadcast/multicast file correction information by including a session description (sessionDescription) and a position (sessionDescriptionURI) in which the session description can be referred to in the associated message.

21. The transmitter of claim 20, wherein the message generator determines whether to include the session description in the associated message, generates the session description if the session description is to be included in the associated message, and generates the broadcast/multicast file correction information by including the generated session description.

22. The transmitter of claim 21, wherein the message generator checks a position (sessionDescriptionURI) in which the session description can be referred to if the session description is not to be included in the associated message, and generates the broadcast/multicast file correction information by including the checked position.

23. The transmitter of claim 18, wherein if the associated message is for reception report request generation, the message generator extracts a sample percentage (samplePercentage) that is sample information for determining whether to transmit a reception report, selects a reception report type, and generates a reception report request including the sample percentage, the reception report type, and a server list of servers to which a reception report is to be transmitted.

24. The transmitter of claim 23, wherein when the message generator selects the reception report type, it selects one of a reception success report (receptionAcknowledgement: RAck), a statistical information report (statisticalReporting: StaR) including session information associated with a successful reception, and a statistical information report (statisticalReporting for all reception: StaR-all) associated with all receptions.

25. The transmitter of claim 23, wherein when the message generator extracts the sample percentage, it extracts a random decimal number having three decimal places between 0 and 100 using statistical uniform distribution sampling.

26. A receiver for receiving a trust guarantee service in a portable broadcasting service, the receiver comprising:
a demodulator for receiving a signal from a service provider through a network and demodulating the received signal;
a demultiplexer for demultiplexing the demodulated signal;
a decapsulator for decapsulating an IP encapsulated packet of the demultiplexed signal for demodulation into an IP stream; and
a message processor for transmitting a file correction request or a reception report to the service provider according to a request included in an associated message of the IP stream.

27. The receiver of claim 26, wherein if the associated message includes a file correction request, the message processor calculates a random delay time using a back-off time and actuating a timer and transmits the file correction request to the service provider if the random delay time is greater or equal to than a time set in the timer.

28. The receiver of claim 26, wherein if the associated message includes a broadcast/multicast file correction request, the message processor makes a connection to a session for a retransmission request according to a session description.

29. The receiver of claim 28, wherein the message processor determines whether the session description is included in the associated message and makes a connection to a session for a retransmission request according to the session description if the session description is included in the associated message.

30. The receiver of claim 29, wherein if the session description is not included in the associated message, the message processor retrieves a session description from a position in which session information can be referred to and makes a connection to a session for a retransmission request.

31. The receiver of claim 26, wherein if the associated message includes a reception report request, the message processor:
determines a reception report type;
calculates a random number having three decimal places between 0 and 100 using statistical uniform distribution sampling if the reception report type is a statistical information report (statisticalReporting: StaR) including session information associated with a successful reception or a statistical information report (statisticalReporting for all reception: StaR-all) associated with all receptions;
determines if the calculated random number is less than a sample percentage, and;
generates the reception report if the calculated random number is less than the sample percentage.

32. The receiver of claim 31, wherein if the reception report type is a reception success report (receptionAcknowledgement: RAck), the message processor generates the reception report.

33. The receiver of claim 31, wherein the message processor generates a reception report for each reception report type and, if time independence information is set, calculates a back-off time, delays by the calculated time, establishes a new connection, and transmits the reception report to the service provider.

34. The receiver of claim 33, wherein if the time independence information is not set, the message processor generates the reception report and transmits the reception report to the service provider using a current connection.
